(19) United States
(12) Patent Application Publication
(10) Pub. No.: US 2014/0067705 A1
(43) Pub. Date: Mar. 6, 2014

(54) ASSESSING EXTENT OF COMPLETENESS OF SETUP OF A BENEFITS PROGRAM

(71) Applicant: Nagaraj Mohan Hunur, Hyderabad (IN)

(72) Inventor: Nagaraj Mohan Hunur, Hyderabad (IN)

(73) Assignee: Oracle International Corporation, Redwood Shores, CA (US)

(21) Appl. No.: 13/603,415

(22) Filed: Sep. 5, 2012

(51) Int. Cl. G06Q 10/06

(52) U.S. Cl. 705/322

(57) ABSTRACT

An aspect of the present invention facilitates assessing extent of completeness of setup of benefits programs for an enterprise. In one embodiment, a digital processing system in response to receiving (from an administrator of the enterprise) data indicating a benefit program identifies the benefit options contained in the indicated benefits program. The system then determines whether each of the identified benefit options has any violations in the corresponding setup. The system then computes a score for the benefits programs based on the determination, with the score representing an extent of completeness of setup of the indicated benefits program. The computed score is then provided (to the administrator) as a response to the receiving of the data.

### RELATED APPLICATIONS

The present application is related to the co-pending US patent application entitled, “MANAGING AND VALIDATING A BENEFITS PLAN”, Ser. No. 12/395,435, Filed date 27-Feb.-2009, naming the same inventors as in the subject patent application.

### BACKGROUND OF INVENTION

1. Technical Field

The present disclosure relates to application servers used for human capital management, and more specifically to assessing extent of completeness of setup of a benefits program.

2. Related Art

Benefits programs refer to a collection of various benefit options provided to the employees of an enterprise. Each benefit option generally refers to a tangible benefit in one of dental, medical, retirement and life insurance, etc. Benefits programs are often deployed using digital processing systems in an enterprise, such that employees of the enterprise can thereafter avail of desired and eligible benefit options.

It is generally desirable to setup a benefits program prior to deployment in the digital processing systems. Setting up generally entails configuration of various parameters associated with each benefit option to implement the benefits policies of the enterprise. Each benefit policy typically specifies the conditions (e.g., group/title/class of persons) of eligibility for the benefit, the details of the benefit provided to the subscribing employees, details of contributions required from the employee, start/end dates when the benefit option is in effect, etc.

There is often a need to assess the extent of completeness of setup of a benefits program. Such assessment may be useful, for example, to determine whether the benefits program is ready for deployment.

### BRIEF DESCRIPTION OF THE DRAWINGS

Example embodiments of the present invention will be described with reference to the accompanying drawings briefly described below.

FIG. 1 is block diagram illustrating an example computing system in which several aspects of the present invention can be implemented.

FIG. 2 is a flow chart illustrating the manner in which assessing extent of completeness of setup of a benefits program is facilitated according to an aspect of the present invention.

FIG. 3A depicts a (hierarchical) structure of a benefits program in one embodiment.

FIG. 3B depicts portions of data representing a (hierarchical) benefits program in one embodiment.

FIG. 4 is a flow chart illustrating the manner in which assessing extent of completeness of setup of a hierarchical benefits program is performed according to an aspect of the present invention.

FIGS. 5A-5B together depicts the manner in which administrators (of an enterprise) are facilitated to assess extent of completeness of setup of benefits programs in one embodiment.

FIG. 6 is a block diagram illustrating the details of a digital processing system in which several aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention facilitates assessing extent of completeness of setup of benefits programs for an enterprise. In one embodiment, a digital processing system in response to receiving (from an administrator of the enterprise) data indicating a benefit program identifies the benefit options contained in the indicated benefits program. The system then determines whether each of the identified benefit options has any violations in the corresponding setup. The system then computes a score for the benefits programs based on the determination, with the score representing an extent of completeness of setup of the indicated benefits program. The computed score is then provided (to the administrator) as a response to the receiving of the data.

Thus, an administrator of an enterprise based on the computed score provided by the digital processing system, is enabled to assess the extent of completeness of setup of any desired benefits program. The administrator may accordingly also determine the benefits programs that are ready for deployment.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

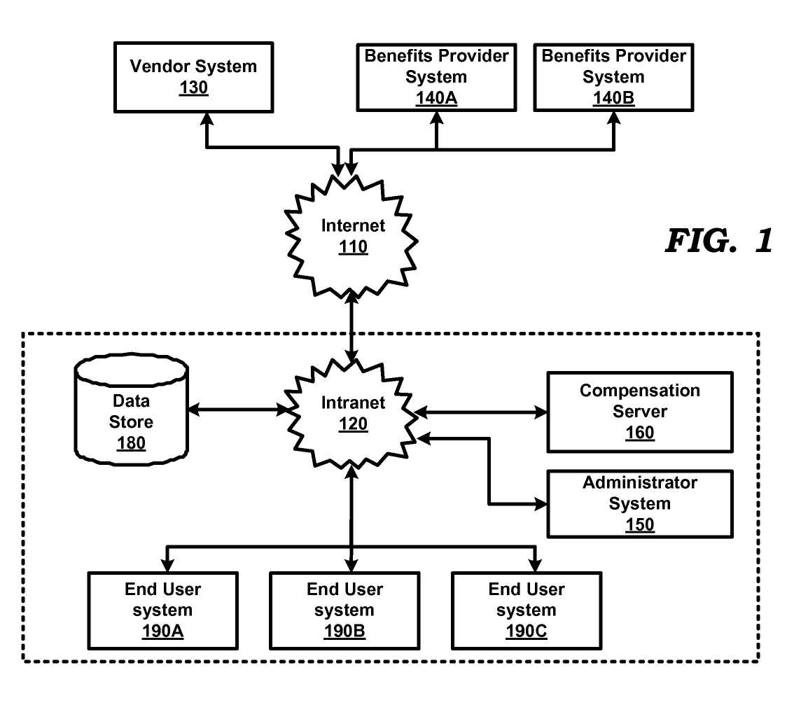

FIG. 1 is block diagram illustrating an example environment in which several aspects of the present invention can be implemented. The block diagram (computing system) is shown containing Internet 110, intranet 120, vendor system 130, benefits provider systems 140A-140B, administrator system 150, compensation server 160, data store 180 and end user systems 190A-190C.

Merely for illustration, only representative number/type of systems is shown in FIG. 1. Many environments often contain many more servers, systems, both in number and type, depending on the vendor who uses the invention. Each system/device of FIG. 1 is described below in further detail.

Intranet 120 represents a network providing connectivity between administrator system 150, compensation server 160, and end user systems 190A-190C, all provided within an enterprise (as shown with dotted boundary). Internet 110 extends the connectivity of these (and other systems of the enterprise) with external systems such as vendor system 130 and benefits provider systems 140A-140B. Each of intranet 120 and Internet 110 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by intranet 120 and Internet 110.

Vendor system 130 represents a system that facilitates one or more vendors of enterprise software to provide their software to various customer organizations (such as the enterprise noted above). The software may be provided to the customer organizations by way of downloading on Internet 110 or by mediums such as optical disks, tape drives, etc. (for example, in response to placing an order using vendor system 130). An example of enterprise software is benefits management software (for managing the benefits provided to the employees of an enterprise/organization) such as Oracle Human Capital Management (HCM), component of the Oracle Fusion Suite, both provided by the vendor Oracle Corporation, the intended assignee of the present application. Other examples include the Benefits solutions from SAP Corporation, Workday software available from Workday Corporation, etc.

Each of benefits provider systems 140A-140B represents a provider or third party administrator organizations such as Aetna, HMO (health maintenance organization), etc., that provide various benefits to individual employees of a contracting organization (for example, the enterprise shown in the dotted boundary). The details of each benefit may be made available electronically by benefits provider systems 140A-140B to users (employees, administrators, etc.) of the enterprise via Internet 110. The enterprise shown in the dotted boundary may then decide upon the eligibility, duration, the tangible part of benefits, etc. The benefits provider systems would provide a cost that would be incurred for managing and providing the decided benefits. These costs are then passed on to the employees or shared by the employer (enterprise) and employees.

Compensation server 160 represents a server, such as a web/application server (or a cluster of such systems), executing enterprise applications such as one or more instances of benefits management software (downloaded/received from vendor system 130). In response to receiving requests from end user system 190A-190C, compensation server 160 performs the tasks specified in the requests and sends the result of performance of the tasks to the requesting end user system (one of 190A-190C).

Examples of such tasks include but are not limited to providing the details of benefits programs offered by the enterprise, the various benefit options constituting each program, the details of the benefits options eligible for a user/employee, etc. Compensation server 160 may use data stored internally (for example, in a non-volatile storage/hard disk within the server), external data maintained in data store 180 and/or data received from external sources (e.g., from the user) in performing such tasks. Such end user requested tasks are performed only after the benefits management software is properly setup and deployed by an administrator of the enterprise.

Data store 180 represents a non-volatile (persistent) storage facilitating storage and retrieval of a collection of data by applications executing in compensation server 160 and administrator system 150. For example, data store 180 may contain details of the benefits programs, benefits options, etc., stored by administrator system 150 and later retrieved by instances of benefits management software executing in compensation server 160. Data store 180 may also store the details of specific benefits subscribed by each employee after deployment of the properly setup benefits management software (in compensation server 160).

Data store 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of end user systems 190A-190C represents a system such as a personal computer, workstation, mobile device, tablets, etc., used by users/employees of the enterprise/customer organization to generate requests directed to applications executing in compensation server 160. The requests may be generated using appropriate user interfaces (e.g., web pages provided by the enterprise application). Thus, an employee of the enterprise requests an instance of the benefits management software for performing desired tasks (such as those noted above) and receives corresponding responses containing the results of performance of the requested tasks. Each server request is sent in the form of an IP packet directed to compensation server 160 (and enterprise application), with the IP packet including data identifying the desired tasks in the payload portion.

It may be appreciated that the same benefits management software is provided to several customer organizations, though only a single organization (the enterprise indicated by the dotted boundary) is shown in the figures. Each of the customer organizations (after downloading or receiving the software) may use the software as suited in their environment and accordingly customize the software to meet the organization's specific requirements prior to deployment in compensation server 160.

Customization entails setting up (as noted in the Background section) of the benefits options and the benefits programs offered to employees of the enterprise. Such customization of the software may be necessitated by the different benefits offered by different provider organizations, the different classes/groups of employees and employee related members sought to be covered by the benefits program, the different types of benefits sought to be offered to the employees, etc.

Administrator system 150 represents a system such as a personal computer, workstation, mobile device, tablets, etc., used by users/administrators to setup the benefits programs of an enterprise (as shown by the dotted boundary). In particular, administrator system 150 provides various user interfaces that facilitate an administrator to specify the details of the benefits programs and corresponding benefits options, and then stores the user specified details in data store 180. The administrator may also access the details of various benefits offered by the provider organizations (by sending appropriate requests to benefits provider systems 140A-140B and receiving corresponding responses) for setting up the benefits programs of the enterprise.

After customization/setting up, data specifying the desired/setup benefits programs is stored in data store 180, with one or more instances of the software executing in compensation server 160 operating (provide benefits to employees) according to the stored data. The employees are thereafter allowed access to the setup benefits programs, and are according enabled to avail the desired and eligible benefit options (using one of end user systems 190A-190C).

It may be desirable that the customized benefits software be deployed on compensation server 160 only after the desired benefits programs (and also options) have been setup completely and accurately. In one embodiment, an administrator may wish to assess the extent of completeness (and also correctness) of setup of each benefits program before identifying the specific benefits programs that are ready for deployment in compensation server 160.

In one prior approach, an administrator is required to manually check the setup of each of the benefits options in each of the benefits programs of the enterprise. Such a manual approach required a large amount to time and resources to be spent by the administrator for assessing the completeness of benefits programs. Furthermore, such a manual approach may not be feasible when the number of benefit options and the number of benefits programs is very large (in the range of few thousands).

It may be further desirable that the administrators of the enterprise be provided an overall picture of the setup of the benefit programs and probable issues within an enterprise, errors or issues in the setup of the options and programs, and a rating on the quality of the setup of each benefits program. Furthermore, it may be desirable that the amount of time spent by administrators in analyzing the design of the benefits programs (for identifying some of the issues noted above) be also reduced.

Administrator system 150, extended according to several aspects of the present invention, facilitates assessing extent of completeness of setup of a benefits program, as described below with examples.

### 3. Assessing Extent of Completeness of Setup of a Benefits Program

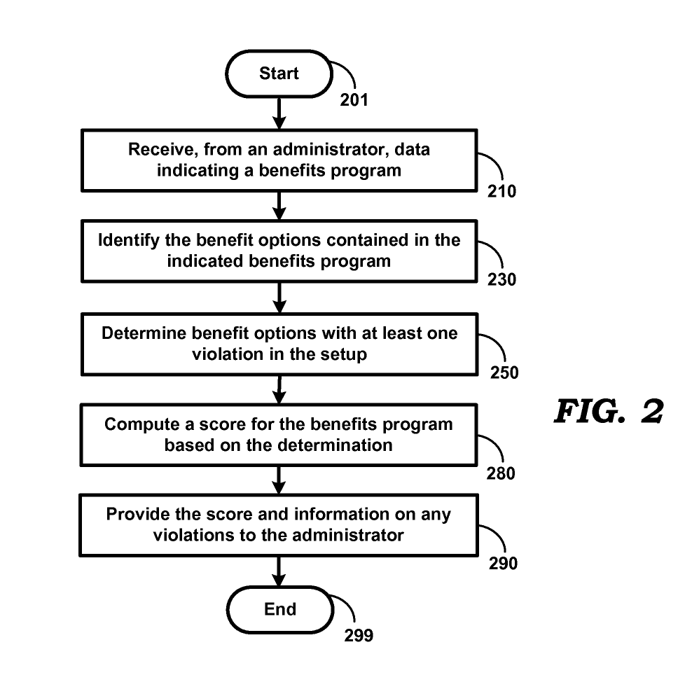

FIG. 2 is a flow chart illustrating the manner in which assessing extent of completeness of setup of a benefits program is facilitated according to an aspect of the present invention. The flowchart is described with respect to FIG. 1 for illustration purposes. However, the features of the present invention can be implemented in other environments also without departing from the scope and spirit of several aspects of the current invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. The flow chart begins in step 201, in which control immediately passes to step 210.

In step 210, administrator system 150 receives, from an administrator, data indicating a benefits program. The identifier may be provided by the administrator using an appropriate user interface provided on a display unit (not shown in FIG. 1) associated with administrator system 150.

In step 230, administrator system 150 identifies the benefit options contained in the indicated benefits program. The identification may entail inspecting a data store (e.g., 180) storing the various benefits programs setup for the enterprise and retrieving only the data corresponding to the benefit options contained in the indicated benefits program.

In step 250, administrator system 150 determines benefit options with at least one violation in the setup. A violation is deemed to be present when the setup of the benefits option is incomplete (when data that is required for completeness has not been specified by an administrator) or incorrect (when data is not consistent with the setup of other benefit options, etc.). Examples of incomplete and/or incorrect setup would be a) duration or year periods are not specified; b) the programs and plans (containing the options) are not set to active; c) the programs or plans are not made available as part of any events; and d) plans which allow beneficiaries to be provided are missing the relevant setup. The data corresponding to the benefit options retrieved from the data store (180) may be examined to determine the benefit options having violations.

In step 280, administrator system 150 computes a score for the benefits program based on the determination. The score may indicate the extent of completeness of setup of the benefits program. For example, a score of 100 may indicate that the benefits program is setup completely and is ready for deployment in compensation server 160, while a score less than 100 may indicate that the setup is incomplete. The score may be computed based on the number of benefit options having at least one violation and/or the number of violations determined for each benefit option.

In step 290, administrator system 150 provides the score and information on violations (if any) to the administrator (from whom the identifier of the benefits program was received in step 210). The score and the information on the violations may be displayed on the display unit associated with administrator system 150. The score and information may be provided to other administrators as well, different from the administrator from whom the request in step 210 is received. The flow chart ends in step 299.

Thus, an administrator of the enterprise is enabled to assess extent of completeness of setup of a benefits program. Furthermore, displaying a score represents a rating of the quality of setup of the benefits program and information on the determined violations facilitates the administrator to have an overall picture of the setup of the benefit programs and probable issues within an enterprise.

The manner in which administrator system 150 assesses extent of completeness of setup of a benefits program according to the steps of FIG. 2 is described below with examples.

### 4. Illustrative Example

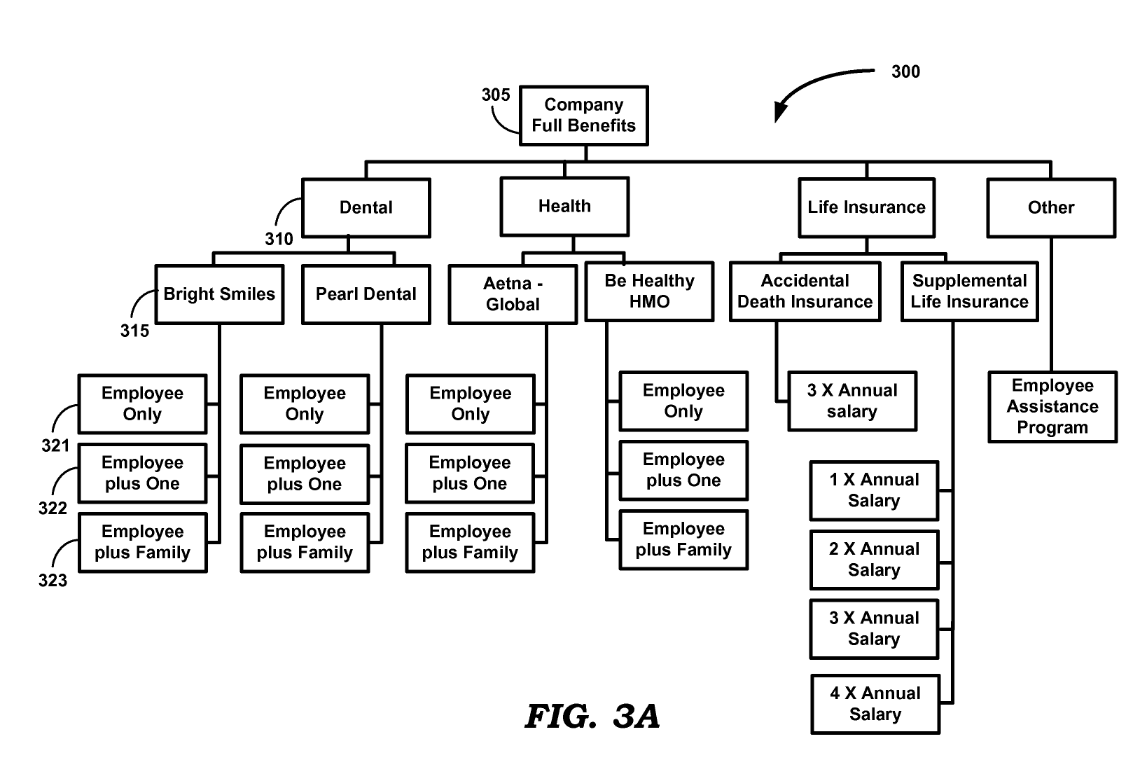

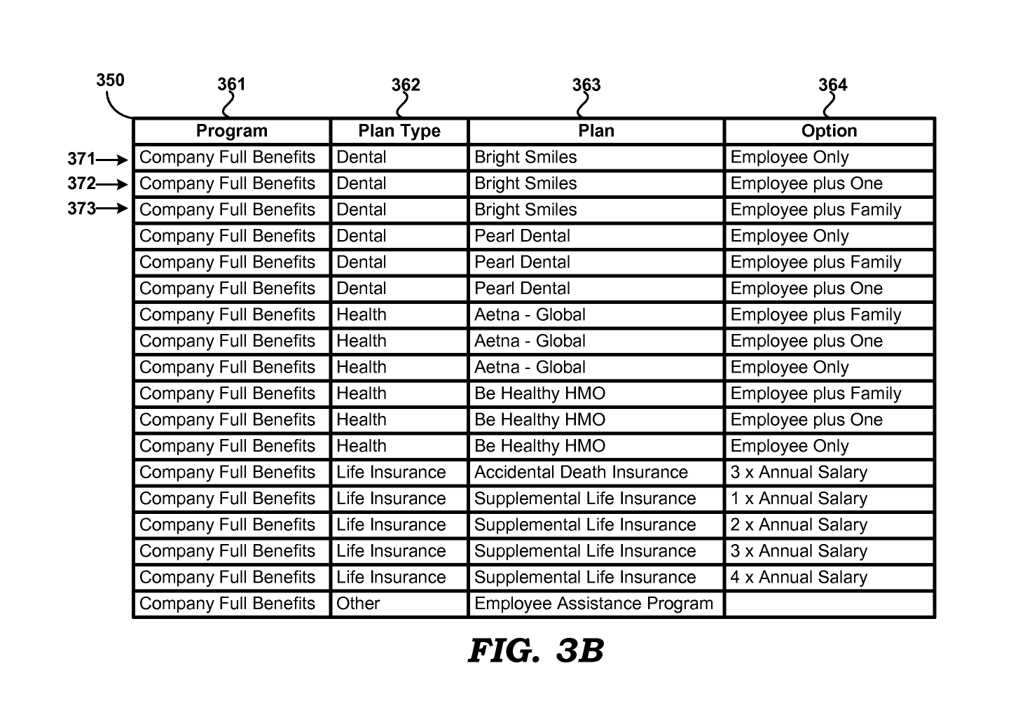

FIGS. 3A-3B, 4 and 5A-5B together illustrate the manner in which assessment of setup of a benefits program is performed in one embodiment. Each of the Figures is described in detail below.

FIG. 3A depicts a structure of a benefits program in one embodiment. In particular, the benefits program is shown organized as a hierarchy 300, with benefits program 305 named “Company Full Benefits” as the root node and other entities (such as plan type, plan, and option) at different levels in the hierarchy. The plan type entities such as Dental 310, Health, Life Insurance, etc. are shown organized as child nodes of the root 305 (at a first level). Each plan type entity (e.g. 310) in turn is shown having a corresponding set of plan entities such as Bright Smiles 315, Pearl Dental, etc. as child nodes (at a second level).

Each plan entity (e.g. 315) is shown containing a corresponding set of (benefit) option entities such as Employee Only 321, Employee plus One 322, Employee plus Family 323, etc. as child nodes (at a third level). It may be observed that each of the option entities does not have any child nodes, and are accordingly referred to as a leaf node/entity, consistent with the terminology in the context of tree-type data structures. Only a sample set of entities and levels are shown in hierarchy 300 for illustration. However, in alternative embodiments, the hierarchy may contain less or more number of entities and levels, as will be apparent to one skilled in the relevant arts.

The description is continued illustrating the manner in which data representing the hierarchically organized benefits program 300 is maintained (in data store 180) in one embodiment.

FIG. 3B depicts portions of data representing a benefits program (in particular program 300 shown in FIG. 3A) in one embodiment. As may be readily observed, the data is shown in flat single table format, representing the hierarchy of FIG. 3A. However, alternative approaches can be employed to represent the hierarchy using techniques such as using different data formats such as extensible markup language (XML) or by using multiple normalized tables (having primary and foreign keys), as will be apparent to one skilled in the relevant arts by reading the disclosure herein.

Table 350 represents a table in a database maintained in data store 180 (representing a relational database server, as noted above). Each of columns 361-363 respectively indicates the names of the benefits program, the plan type and the plan in which the corresponding option (indicated in column 364) is contained. Thus, row 371 indicates that the Employee Only benefits option (321 in hierarchy 300) is contained in the Company Full Benefits program, the Dental plan type and Bright Smiles plan. Similarly, rows 371-373 respectively indicate the details of benefits options 322 and 323 in hierarchy 300.

Thus, FIGS. 3A and 3B together illustrate a hierarchically organized benefits program whose extent of completeness of setup may be desired to be assessed (by an administrator of the enterprise) before deployment in compensation server 160. The manner in which administrator system 150 assesses such a hierarchical benefits program is described below with examples.

### 5. Assessing a Hierarchical Benefits Program

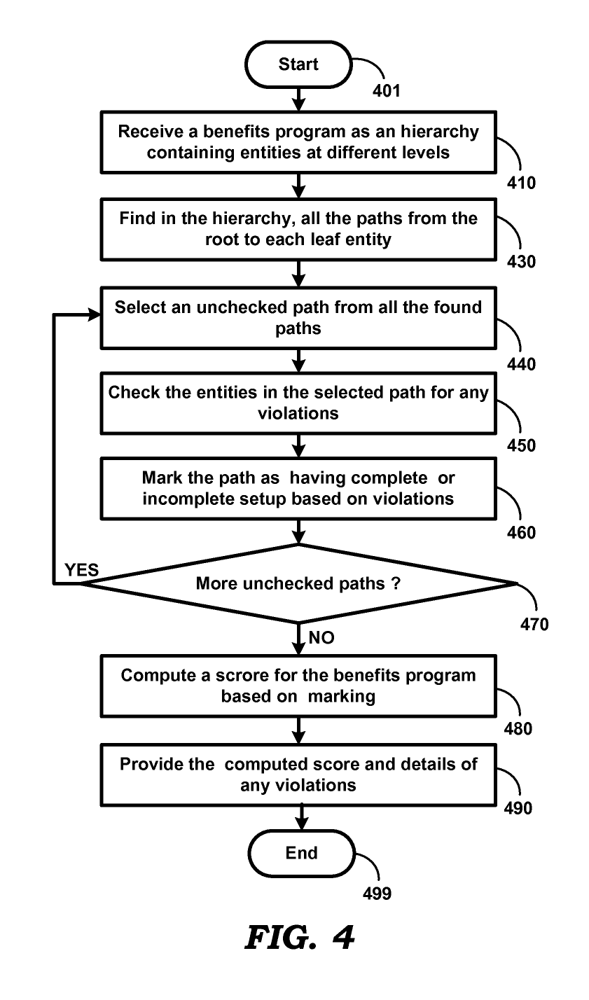

FIG. 4 is a flow chart illustrating the manner in which assessing extent of completeness of setup of a hierarchical benefits program is performed according to an aspect of the present invention. The flowchart is described with respect to FIGS. 1 and 3A-3B for illustration purposes. However, the features of the present invention can be implemented in other environments also without departing from the scope and spirit of several aspects of the current invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. The flow chart begins in step 401, in which control immediately passes to step 410.

In step 410, administrator system 150 receives a benefits program in the form of a hierarchy (e.g. 300) containing entities (such as plan type, plan and option) at different levels (such as first, second and third noted above). The administrator system 150 may receive data indicating the benefits program (step 210) from an administrator of the enterprise.

In step 430, administrator system 150 finds in the hierarchy, all the paths from the root (benefits program 305) to each leaf entity (option entity in hierarchy 300). Each leaf entity in the hierarchy represents a corresponding benefit option provided to the employees of the enterprise, and accordingly finding of all the paths to the leaf entities in the hierarchy ensures that all the benefits options in the benefits program are checked for completeness of setup.

A path to a leaf node/entity represents the set of nodes connecting the root to the leaf entity in the hierarchy. Thus, each path to a leaf node contains the root node and one node from each level under the root node (including the leaf node at the last level). For example, the set of nodes 305-310-315-321, 305-310-315-322, and 305-310-315-323 represents corresponding paths to each of leaf entities 321-323.

It should be noted that the steps of 410 and 430 may be performed according to the manner in which the data representing the hierarchically organized benefits program is maintained. In the scenario that the data is maintained as a single table (350), administrator system 150 may receive an identifier of the benefits program sought to be accessed (“Company Full Benefits”), retrieve the data corresponding to the received identifier (that is, all the rows of table 350), and then identify the paths as corresponding to the retrieved rows in the table, since each row in table 350 represents a corresponding benefit option in the benefits program.

Alternatively, when the data is maintained in another format (such as XML), administrator system 150 retrieves the data representing the indicated hierarchical benefits program from a data store (such as 180) and then constructs the hierarchy (300) in memory based on the retrieved data. The leaf entities and their corresponding paths may be thereafter identified by performing a breadth first or depth first traversal of the in-memory hierarchy, as is well known in the arts. The manner in which each of the paths (found/identified) in the hierarchy is processed is described below in detail.

In step 440, administrator system 150 selects an unchecked path from the set of all the found paths. The selection may be performed in a known way. For example, the paths may be maintained in the form of a list. A pointer to the location in the list of the next unchecked path is also maintained, with the pointer being initially set to the beginning of the list. Accordingly, the path in the location pointed to by the pointer is selected in step 440. Alternatively, each of the paths may be associated with a corresponding flag indicating whether the path has been checked (value ‘T’) or not (value ‘F’). Administrator system 150 checks the values of the flags, and selects a path associated with the flag value ‘F’ in step 440.

In step 450, administrator system 150 checks the entities in the selected path for any violations in the corresponding setup. It should be appreciated that each entity/node may have fields for storing associated configuration data, and the values stored in such fields may be examined to check for any violations for that node. It may be readily understood that configuration causes the user provided values to be stored in such fields.

Thus, the violations in the correctness of the setup of the leaf entity (and also other entities in the selected path) are determined based on the setup of the parent nodes in the selected path. For example, the violations in the setup of benefit option “Employee Only” 321 is determined based on the setup of 321 (for completeness), and the setup of nodes 315 and 310 (for correctness).

In step 460, administrator system 150 marks the selected path as having complete or incomplete setup based on the violations determined in setup 450. A path may be marked as having a complete setup if there are no violations determined and as having an incomplete setup otherwise.

In one embodiment, administrator system 150 calculates a score for the path based on the determined violations. The score may be calculated based on the number of nodes/entities having at least one violation in the path and/or the number of violations determined for each entity in the path. The calculated score is compared with a perfect score (representing a complete setup, for example, a value of 100) to determine whether the selected path is to be marked as having complete or incomplete setup.

In step 470, administrator system 150 checks whether there exists at least one unchecked path in the set of all found paths. In a scenario that the paths are maintained in the form of a list, the pointer may be updated to point to the next location in the list after step 460 is performed. Administrator system 150 may then determine that there is one unchecked path in step 470 only if the updated pointer is not pointing after the end of the list (i.e., after the last path in the list). Similarly, in the scenario each path is associated with a corresponding flag, administrator system 150 determines that there is one unchecked path if there exits at least one path associated with the flag value ‘F’. Control passes to step 440, if there exists at least one unchecked path and to step 480 otherwise (indicating that all the paths have been checked).

In step 480, administrator system 150 computes an (overall) score of the benefits program based on the marking in step 460. In one embodiment, the overall score is determined as the ratio of the number of paths that have been marked as having a complete (and correct) setup to the total number of paths found in the hierarchy. Paths with only a perfect score (in step 460) are considered as having a complete setup.

In step 490, administrator system 150 provides the computed score and the details of any violations (to an administrator). As noted above, the scores and details of the violations may be displayed on a display unit associated with administrator system 150. The flow chart ends in step 499.

Thus, administrator system 150 assesses the extent of completeness of setup of a hierarchical benefits program (shown in FIG. 3A). The details of the assessment may then be displayed to administrators of the enterprise, as described below with examples.

### 6. Example User Interface

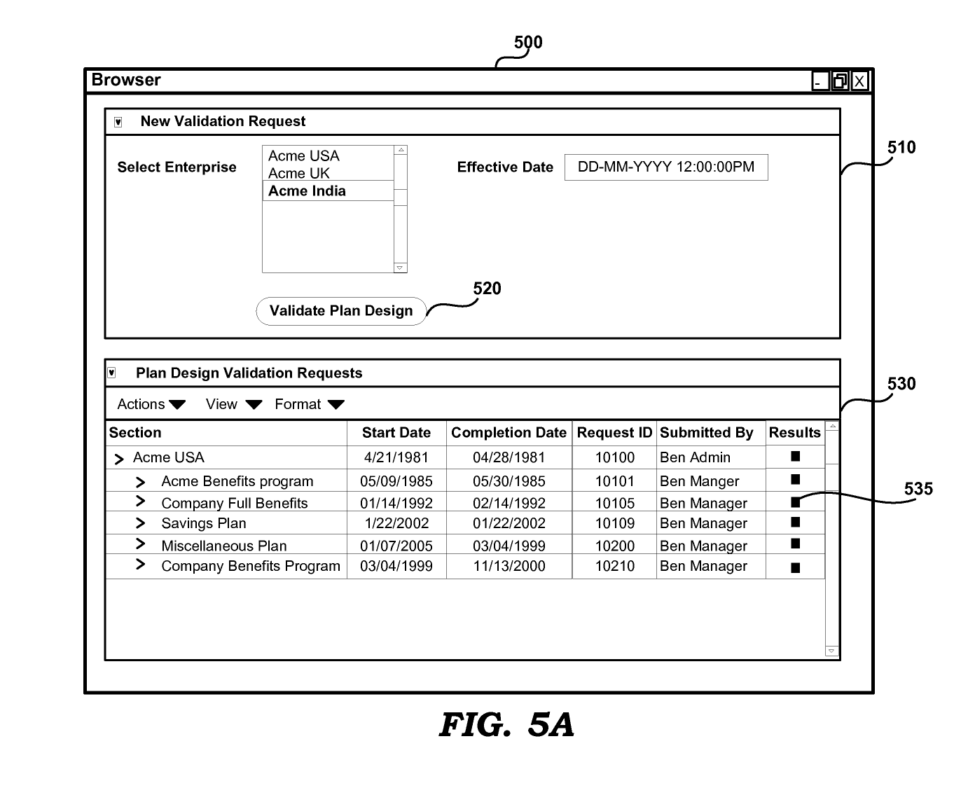

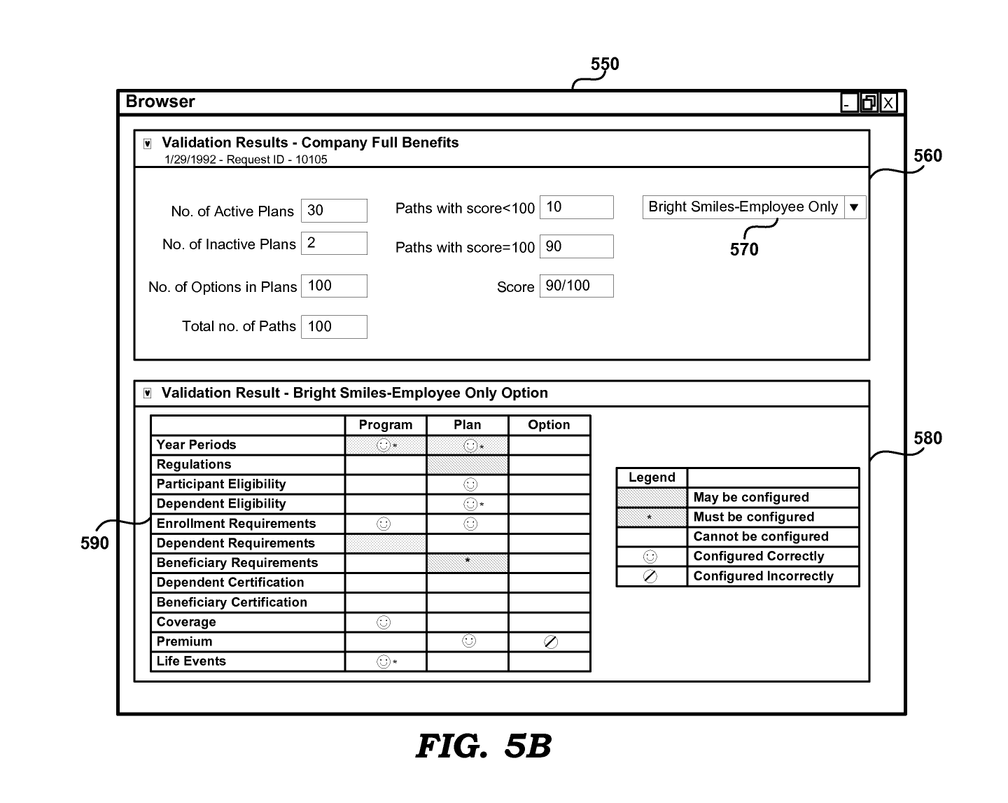

FIGS. 5A-5B together depicts the manner in which administrators (of an enterprise) are facilitated to assess extent of completeness of setup of benefits programs in one embodiment. Each of display area 500 and 550 depicts a portion of a user interface provided on a display unit (not shown in FIG. 1) associated with administrator system 150. In one embodiment, each of display area 500 and 550 corresponds to a browser displaying respective web pages provided by administrator system 150. The web pages are provided in response to an administrator of the enterprise sending appropriate requests, for example, including the uniform resource locators (URLs) of the web pages, to administrator system 150.

Referring to FIG. 5A, display area 510 enables an administrator to select an enterprise (whose benefit programs are sought to be validated/assessed) and an effective date for assessment. The benefit plans/options that are to take effect before the effective date are deemed to be active and are included in the assessment, while the benefit plans/options that are to take effect after effective date are deemed to be inactive and are excluded in the assessment.

After selecting the desired enterprise (for example, Acme India as shown) and specifying a desired effective date (a blank value as shown, indicating that all the plans/actions effective as of the current date are to be included in the assessment), an administrator clicks/selects “Validate Plan Design” button 520 to send a new request for validation of the benefits programs of the selected enterprise.

Display area 530 displays a list of validation requests previously submitted by administrators of the enterprise. In particular, display area 530 indicates that a validation requests for and that different benefits programs setup for the enterprise “Acme USA” has already been submitted. An administrator may click on the corresponding button (shown as a filled rectangle) provided in the Results column to view the results. The description is continued assuming that an administrator has clicked/selected the button 535 for viewing the validation/assessment results of the benefits program named “Company Full Benefits”.

Referring to FIG. 5B, display area 560 is shown displaying the validation results of the “Company Full Benefits” benefits program (as indicated by the title of the display area 560). In particular, display area 560 indicates the number of active/inactive (based on the effective date) plan entities as 30 and 2 respectively, and the number of options in the active plans (which is the same as the number of paths in the hierarchy) as 100. Display area 560 also indicates the number of paths having scores less than 100 (that is, paths whose setup is incomplete) as 10, the number of paths having scores equal to 100 (that is, paths whose setup is complete) as 90, and an overall score for the benefits program as 90/100 (the ratio of the number of paths whose setup is complete to the total number of paths).

In addition, select field 570 provides (when selected) a list of paths/benefit options that have a violation, that is, the benefit options whose setup is not completed or not correct. For convenience, each incomplete benefits option is identified by the name of the parent plan entity (e.g. “Bright Smiles”) concatenated with the name of the option (e.g. “Employee Only”). An administrator may select any of the benefit option in select field 570 and view the details of the issues with the setup of the selected benefit option in display area 580. The administrator is shown selecting the benefit option “Bright Smiles-Employee Only” in select field 570. Display area 580 is accordingly shown displaying the details of the setup of the “Bright Smiles-Employee Only” benefit option.

Display area 590 indicates whether the setup of different parameters (configurable fields) such as “Year Periods”, “Regulations”, “Participant Eligibility”, etc. (shown in the first column) for each of the program “Company Full Benefits”, plan “Bright Smiles” and option “Employee Only” is complete and/or correct. The legend indicates that the setup of the Premium parameter for the option entity is incorrect and also that the setup of the beneficiary requirements for the plan entity is not complete.

The score corresponding to the benefits option may be calculated as the percentage of completely setup parameters to the total number of parameters. Thus, for the Employee Only benefits option shown in display area 590, the score may be calculated as 11/13*100=84, and is accordingly identified as having incomplete setup (since the calculated score is less than 100). An administrator may similarly select other benefit option in select field 570 and the view the details of the setup of the selection option in display area 580.

Thus, the user interfaces of FIGS. 5A and 5B facilitates administrators of an enterprise to assess the completeness of setup of benefits programs of the enterprise. Furthermore, the administrator is enabled to identify the specific issues in the setup of each benefits program, and also the specific benefits programs that are ready to be deployed in compensation server 160.

It should be appreciated that the features described above can be implemented in various embodiments as a desired combination of one or more of hardware, executable modules, and firmware. The description is continued with respect to an embodiment in which various features are operative when executable modules are executed.

### 7. Digital Processing System

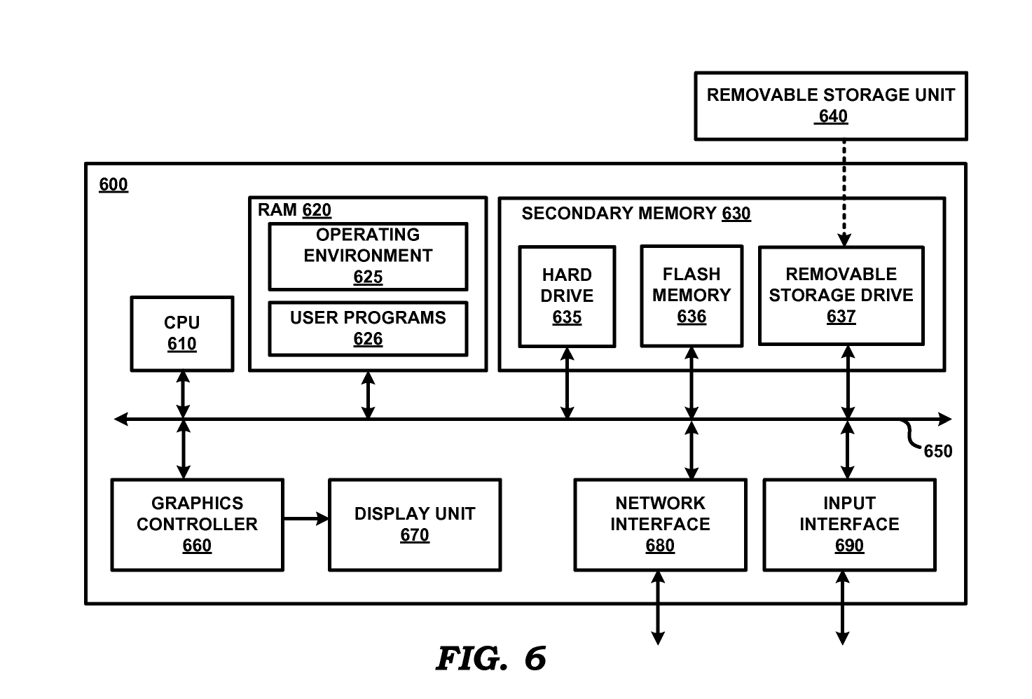

FIG. 6 is a block diagram illustrating the details of digital processing system 600 in which various aspects of the present invention are operative by execution of appropriate executable modules. Digital processing system 600 may correspond to administrator system 150.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting operating environment 625 and/or other user programs 626 (such as the instances of benefits management software in an enterprise, etc.). In addition to operating environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Each of the displays shown in FIGS. 5A-5B corresponds to an image screen at corresponding time duration on the display screen. Input interface 690 may correspond to a keyboard and a pointing device (e.g., touch-pad, mouse) and may be used to provide inputs (such as those provided by the administrators of the enterprise using the interfaces of FIGS. 5A-5B as described above). Network interface 680 provides connectivity to a network (e.g., using Internet Protocol), and may be used to communicate with other systems connected to the network (such as compensation server 160, data store 180, etc.).

Secondary memory 630 may contain hard drive 635, flash memory 636, and removable storage drive 637. Secondary memory 630 may store the data (for example, portions of the data shown in FIG. 3B, the data entered by an administrator in the interfaces of FIGS. 5A-5B, etc.) and software instructions (for implementing the steps of FIGS. 2 and 4), which enable digital processing system 600 to provide several features in accordance with the present invention.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 8. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method of assessing extent of completeness of setup of benefits programs for an enterprise, said method being performed in an administrator system, said method comprising:
receiving, from an administrator, data indicating a first benefits program;
identifying a plurality of benefit options contained in said first benefits program, wherein each of said plurality of benefit options comprises corresponding one or more parameters required to be configured to specify eligibility criteria for users of said first benefits program;
determining whether each of said plurality of benefit options has any violations in the corresponding setup, wherein a violation in the setup of a benefit option comprises at least one of non-specification, incomplete specification and incorrect specification of the corresponding one or more parameters of the benefit option;
computing a score for said benefits program based on said determining, said score representing an extent of completeness of setup of said first benefits program; and
providing said score to said administrator as a response to said receiving,
said administrator system comprising a processor and a memory, said processor retrieving and executing instructions from said memory to perform said receiving, said identifying, said determining, said computing and said providing.

2. The method of claim 21, wherein said determining determines a first subset of benefit options as having no violations in the corresponding setup, said first subset of benefit options being contained in said plurality of benefit options,
wherein said computing computes said score as a ratio of the number of benefit options in said first subset of benefit options to the number of benefit options in said plurality of benefit options.

3. The method of claim 2, wherein said providing further provides a list of benefit options having at least one violation in the corresponding setup, said list of benefit options being contained in said plurality of benefit options,
wherein in response to said administrator selecting a first benefit option from said list of benefit options, said providing further provides information on the violations in the setup of said first benefit option.

4. The method of claim 2, wherein said first benefits program is represented in the form of a hierarchy, with said plurality of benefit options being located as leaf nodes of said hierarchy and said first benefits program being located as a root node of said hierarchy,
said identifying comprising finding a plurality of paths in said hierarchy, with each path starting from said root node and ending at corresponding one of said leaf nodes of said hierarchy.

5. The method of claim 4, wherein said determining comprises:
selecting a first path of said plurality of paths, said first path ending at a first benefit option;
checking the setup of said first benefit option for any violations;
marking said first benefit option as having a complete setup if said checking determines that the setup of the first benefit option has no violations; and
iteratively performing said selecting, said checking and said marking for each of said plurality of paths.

6. The method of claim 5, wherein said checking comprises:
calculating a first score for said first benefit option based on the number of violations identified in the setup of said first benefit option; and
comparing said first score with a full score, wherein said full score indicates that the corresponding option has no violations,
wherein said marking marks said first benefit option as having complete setup if said first score is equal to said full score,
wherein said computing computes said score as a ratio of the number of paths marked as having complete setup to the number of paths in said plurality of paths.

7. (canceled)

8. A non-transitory machine readable medium storing one or more sequences of instructions for causing a system to assess extent of completeness of setup of benefits programs for an enterprise, wherein execution of said one or more instructions by one or more processors contained in said system causes said system to perform the actions of:
receiving, from an administrator, data indicating a first benefits program;
identifying a plurality of benefit options contained in said first benefits program, wherein each of said plurality of benefit options comprises corresponding one or more parameters required to be configured to specify eligibility criteria for users of said first benefits program;
determining whether each of said plurality of benefit options has any violations in the corresponding setup, wherein a violation in the setup of a benefit option comprises at least one of non-specification, incomplete specification and incorrect specification of the corresponding one or more parameters of the benefit option;
computing a score for said benefits program based on said determining, said score representing an extent of completeness of setup of said first benefits program; and
providing said score to said administrator as a response to said receiving.

9. The machine readable medium of claim 22, wherein said determining determines a first subset of benefit options as having no violations in the corresponding setup, said first subset of benefit options being contained in said plurality of benefit options,
wherein said computing computes said score as a ratio of the number of benefit options in said first subset of benefit options to the number of benefit options in said plurality of benefit options.

10. The machine readable medium of claim 9, wherein said providing further provides a list of benefit options having at least one violation in the corresponding setup, said list of benefit options being contained in said plurality of benefit options,
wherein in response to said administrator selecting a first benefit option from said list of benefit options, said providing further provides information on the violations in the setup of said first benefit option.

11. The machine readable medium of claim 9, wherein said first benefits program is represented in the form of a hierarchy, with said plurality of benefit options being located as leaf nodes of said hierarchy and said first benefits program being located as a root node of said hierarchy,
said identifying comprising one or more instructions for finding a plurality of paths in said hierarchy, with each path starting from said root node and ending at corresponding one of said leaf nodes of said hierarchy.

12. The machine readable medium of claim 11, wherein said determining comprises one or more instructions for:
selecting a first path of said plurality of paths, said first path ending at a first benefit option;
checking the setup of said first benefit option for any violations;
marking said first benefit option as having a complete setup if said checking determines that the setup of the first benefit option has no violations; and
iteratively performing said selecting, said checking and said marking for each of said plurality of paths.

13. The machine readable medium of claim 12, wherein said checking comprises one or more instructions for:
calculating a first score for said first benefit option based on the number of violations identified in the setup of said first benefit option; and
comparing said first score with a full score, wherein said full score indicates that the corresponding option has no violations,
wherein said marking marks said first benefit option as having complete setup if said first score is equal to said full score,
wherein said computing computes said score as a ratio of the number of paths marked as having complete setup to the number of paths in said plurality of paths.

14. (canceled)

15. A digital processing system comprising:
a processor;
a random access memory (RAM);
a machine readable medium to store one or more instructions, which when retrieved into said RAM and executed by said processor causes said digital processing system to assess extent of completeness of setup of benefits programs for an enterprise, said digital processing system performing the actions of:
receiving, from an administrator, data indicating a first benefits program;
identifying a plurality of benefit options contained in said first benefits program, wherein each of said plurality of benefit options comprises corresponding one or more parameters required to be configured to specify eligibility criteria for users of said first benefits program;
determining whether each of said plurality of benefit options has any violations in the corresponding setup, wherein a violation in the setup of a benefit option comprises at least one of non-specification, incomplete specification and incorrect specification of the corresponding one or more parameters of the benefit option;
computing a score for said benefits program based on said determining, said score representing an extent of completeness of setup of said first benefits program; and
providing said score to said administrator as a response to said receiving.

16. The digital processing system of claim 15, wherein said digital processing system determines a first subset of benefit options as having no violations in the corresponding setup, said first subset of benefit options being contained in said plurality of benefit options,
wherein said digital processing system computes said score as a ratio of the number of benefit options in said first subset of benefit options to the number of benefit options in said plurality of benefit options.

17. The digital processing system of claim 16, wherein said digital processing system further provides a list of benefit options having at least one violation in the corresponding setup, said list of benefit options being contained in said plurality of benefit options,
wherein in response to said administrator selecting a first benefit option from said list of benefit options, said digital processing system further provides information on the violations in the setup of said first benefit option.

18. The digital processing system of claim 16, wherein said first benefits program is represented in the form of a hierarchy, with said plurality of benefit options being located as leaf nodes of said hierarchy and said first benefits program being located as a root node of said hierarchy,
wherein for said identifying, said digital processing system finds a plurality of paths in said hierarchy, with each path starting from said root node and ending at corresponding one of said leaf nodes of said hierarchy.

19. The digital processing system of claim 4, wherein for said determining, further performing the actions of:
selecting a first path of said plurality of paths, said first path ending at a first benefit option;
checking the setup of said first benefit option for any violations;
marking said first benefit option as having a complete setup if said checking determines that the setup of the first benefit option has no violations; and
iteratively performing said selecting, said checking and said marking for each of said plurality of paths.

20. The digital processing system of claim 19, wherein for said checking, said digital processing system performs the actions of:
calculating a first score for said first benefit option based on the number of violations identified in the setup of said first benefit option; and
comparing said first score with a full score, wherein said full score indicates that the corresponding option has no violations,
wherein said digital processing system marks said first benefit option as having complete setup if said first score is equal to said full score.

21. the method of claim 1, wherein said first benefits program is deployed on a compensation server for access and use by said users after said administrator completes the setup of said first benefits program on said administrator system,
wherein said receiving, said identifying, said determining, said computing and said providing are performed in said administrator system prior to said deployment of said first benefits program on said compensation server for access and use by said users.

22. The non-transitory machine readable medium of claim 8, wherein said first benefits program is deployed on a compensation server for access and use by said users after said administrator completes the setup of said first benefits program on said administrator system,
wherein said receiving, said identifying, said determining, said computing and said providing are performed in said administrator system prior to said deployment of said first benefits program on said compensation server for access and use by said users.
